(19) United States
(12) Patent Application Publication
(10) Pub. No.: US 2024/0190438 A1
(43) Pub. Date: Jun. 13, 2024

(54) HYBRID ELECTRIC VEHICLE AND METHOD OF CONTROLLING THE SAME

(71) Applicants: Hyundai Motor Company, Seoul (KR); Kia Corporation, Seoul (KR)

(72) Inventors: Gyu Ri Lee, Namyangju-Si (KR); Do Hwa Kim, Gwacheon-Si (KR); Hui Un Son, Suwon-Si (KR); Sung II Jung, Busan (KR); Jae Young Park, Seongnam-Si (KR); Yong Joo Lee, Incheon (KR); Seong Wook Moon, Seoul (KR); Sung Bae Jeon, Hwaseong-Si (KR)

(73) Assignees: Hyundai Motor Company, Seoul (KR); Kia Corporation, Seoul (KR)

(21) Appl. No.: 18/195,669

(22) Filed: May 10, 2023

(30) Foreign Application Priority Data
Dec. 8, 2022 (KR) 10-2022-0170863

(51) Int. Cl. B60W 30/182; B60W 10/06; B60W 10/08; B60W 20/15

(52) U.S. Cl. CPC B60W 30/182; B60W 10/06; B60W 10/08; B60W 20/15; B60W 2510/244; B60W 2510/30

(57) ABSTRACT

A hybrid electric vehicle includes an engine, a drive motor, and a controller configured to determine a boarding state or a leaving state of a passenger, to allow a vehicle to enter a first mode for pick-up driving or a second mode for drop-off driving, and to control the vehicle based on the entered mode and the boarding or leaving state after the entering, and a method of controlling the same.

### CROSS-REFERENCE TO RELATED APPLICATION

The present application claims priority to Korean Patent Application No. 10-2022-0170863, filed on Dec. 8, 2022, the entire contents of which is incorporated herein for all purposes by this reference.

### BACKGROUND OF THE PRESENT DISCLOSURE

### Field of the Present Disclosure

The present disclosure relates to a hybrid electric vehicle including a control strategy specific to a vehicle repeatedly entered and exited by passengers in a fixed manner, such as a school bus, and a method of controlling the same.

### Description of Related Art

With the recent increase in interest in the environment, eco-friendly vehicles each provided with an electric motor as a power source are increasing in number. An eco-friendly vehicle is also referred to as an electrified vehicle, and representative examples thereof include a hybrid electric vehicle (HEV) and an electric vehicle (EV).

The electrified vehicle is provided with a motor, unlike a conventional general internal combustion engine vehicle, and may obtain power necessary for driving through the motor. In particular, in the case of the HEV in which an engine is provided together with a motor, fuel efficiency may be improved by performing mode switching between an EV mode in which only the motor is driven and an HEV mode in which the motor is selectively used while driving the engine according to driving conditions. Furthermore, a battery may be provided to the HEV to drive the motor in each mode. Accordingly, the HEV may drive the motor using a state of charge (SOC) value of the battery variably according to the driving conditions by performing a control operation to maintain the SOC value of the battery at a certain level.

Meanwhile, as supply of HEVs expands, and the HEVs are incorporated and used in various environments, control of the HEVs differentiated for each environment may be necessary. For example, when a hybrid powertrain apparatus is applied to a school bus, a kindergarten school bus, etc., a specialized control strategy needs to be provided to reflect a driving environment where passengers board and leave repeatedly and in a fixed manner, and driving is performed at low speed or stopping frequently occurs.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an HEV configured for ensuring driving safety and driving efficiency by applying a control strategy specific to a vehicle repeatedly entered and exited by passengers, such as a school bus, and a method of controlling the same.

The objects of the present disclosure are not limited to the object mentioned above, and other objects not mentioned herein will be clearly understood by those skilled in the art from the following description.

In accordance with an aspect of the present disclosure, the above and other objects may be accomplished by the provision of an HEV including an engine, a drive motor, and a controller configured to determine a boarding state or a leaving state of a passenger based on at least one of location information of the vehicle or internal information of the vehicle and whether the vehicle is stopped after the vehicle is started, to allow the vehicle to enter a mode among a first mode for pick-up driving or a second mode for drop-off driving based on the determined boarding state or the determined leaving state and time information, and to control the vehicle based on the entered mode and the boarding state or the leaving state after the entering.

In accordance with another aspect of the present disclosure, there is provided a method of controlling an HEV, the method including determining a boarding state or a leaving state of a passenger based on at least one of location information of the vehicle or internal information of the vehicle and whether the vehicle is stopped after the vehicle is started, and allowing the vehicle to enter a mode among a first mode for pick-up driving or a second mode for drop-off driving based on the determined boarding state or the determined leaving state and time information, and controlling the vehicle based on the entered mode and the boarding state or the leaving state after the entering.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a diagram illustrating an example of a configuration of a powertrain apparatus of an HEV applicable to various exemplary embodiments of the present disclosure:

FIG. 2 is a diagram illustrating an example of a configuration of a control system of the HEV according to an exemplary embodiment of the present disclosure:

FIG. 3 is a diagram illustrating an example of a configuration of a controller of the HEV according to an exemplary embodiment of the present disclosure:

FIG. 4 is a diagram for describing a first mode operation of the HEV according to an exemplary embodiment of the present disclosure; and

FIG. 5 is a diagram for describing a second mode operation of the HEV according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

With regard to various exemplary embodiments of the present disclosure included in the present specification or application, specific structural or functional descriptions are only illustrated for describing the exemplary embodiments of the present disclosure, and the exemplary embodiments of the present disclosure may be implemented in various forms. The present disclosure may not be construed as being limited to the exemplary embodiments described in the present specification or application.

Because the present disclosure may have various changes and may have various forms, specific embodiments are illustrated in the drawings and described in detail in the present specification or application. However, the present disclosure is not intended to be limited to the specific disclosed form, and it should be understood to include all modifications, equivalents and substitutes included in the spirit and scope of the present disclosure.

Unless defined otherwise, all terms used herein, including technical or scientific terms, have the same meanings as commonly understood by those skilled in the art to which the present disclosure pertains. Terms such as those defined in commonly used dictionaries should be interpreted as indicating meanings consistent with the meanings in the context of the related art, and should not be interpreted in an ideal or excessively formal way unless explicitly defined in the present application.

Hereinafter, various embodiments of the present disclosure will be described in detail with reference to the accompanying drawings, and the same or similar elements will be provided the same reference numerals regardless of reference symbols, and redundant description thereof will be omitted.

The suffixes “module” and “unit” for components used in the following description are provided or used together in consideration of ease of generating the specification, and do not have meanings or roles distinct from each other.

In describing the exemplary embodiments included in the present specification, when it is determined that a detailed description of related publicly known technology may obscure the gist of the exemplary embodiments included in the present specification, the detailed description thereof will be omitted. Furthermore, it should be understood that the accompanying drawings are only for easy understanding of the exemplary embodiments included in the present specification, the technical idea included in the present specification is not limited by the accompanying drawings, and the present disclosure includes all modifications, equivalents, and substitutes included in the spirit and scope of the present disclosure.

Although terms including ordinal numbers, such as “first”, “second”, etc., may be used herein to describe various elements, the elements are not limited by these terms. These terms are generally only used to distinguish one element from another.

When an element is referred to as being “coupled” or “connected” to another element, the element may be directly coupled or connected to the other element. However, it should be understood that another element may be present therebetween. In contrast, when an element is referred to as being “directly coupled” or “directly connected” to another element, it should be understood that there are no other elements therebetween.

A singular expression includes the plural form unless the context clearly dictates otherwise.

In the present specification, it should be understood that a term such as “include” or “have” is intended to designate that the features, numbers, steps, operations, elements, parts, or combinations thereof described in the specification are present, and does not preclude the possibility of addition or presence of one or more other features, numbers, steps, operations, elements, parts, or combinations thereof.

Furthermore, a unit or control unit included in names such as a motor control unit (MCU) and a hybrid control unit (HCU) is a term widely used for naming controllers for controlling a vehicle-specific function, and does not mean a generic functional unit.

A controller may include a communication device that communicates with another controller or a sensor to control a function assigned thereto, a memory that stores an operating system, a logic command, input/output information, etc., and one or more processors that perform determination, calculation, decision, etc. necessary for controlling a function assigned thereto.

Prior to describing a cut-in response method according to the exemplary embodiments of the present disclosure, a structure and a control system of an HEV applicable to the exemplary embodiments will be described first.

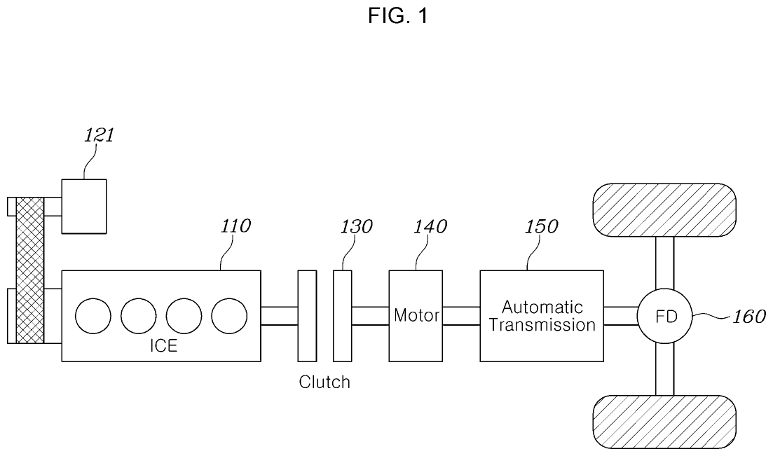

FIG. 1 is a diagram illustrating an example of a configuration of a powertrain apparatus of the HEV applicable to the exemplary embodiments of the present disclosure.

FIG. 1 illustrates the powertrain apparatus of the HEV employing a parallel type hybrid system in which an electric motor (or drive motor, 140) and an engine clutch 130 are provided between an internal combustion engine (ICE) 110 and a transmission 150.

In such a vehicle, in general, when a driver depresses an accelerator pedal after starting (that is, an accelerator pedal sensor is on), the motor 140 is driven using power of a battery first with the engine clutch 130 open, and power of the motor passes through the transmission 150 and a final drive (FD) 160 to move wheels (that is, an EV mode). When the vehicle is gradually accelerated and gradually requires greater driving force, an auxiliary motor (or starter generator motor, 120) may operate to drive the engine 110.

Accordingly, when a rotational speed difference between the engine 110 and the motor 140 falls within a certain range, the engine clutch 130 is engaged, and the engine 110 and the motor 140 drive the vehicle together (that is, transition from the EV mode to an HEV mode). When a preset engine-off condition, such as vehicle deceleration, is satisfied, the engine clutch 130 is opened, and the engine 110 is stopped (that is, transition from the HEV mode to the EV mode). At the instant time, the vehicle charges a battery 170 through the motor 140 using driving force of the wheels, which is referred to as braking energy regeneration or regenerative braking. Therefore, the starter generator motor 120 is configured as a starter motor when the engine is started, operates as a generator when rotational energy of the engine is recovered after the engine is started or when the engine is turned off, and thus may be referred to as a hybrid starter generator (HSG).

In general, as the transmission 150, it is possible to use a stepped transmission or a multi-plate clutch, for example, a dual clutch transmission (DCT).

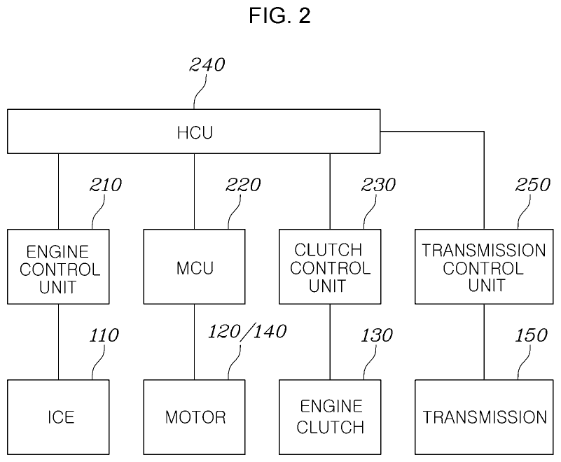

FIG. 2 is a diagram illustrating an example of a configuration of a control system of the HEV according to an exemplary embodiment of the present disclosure.

Referring to FIG. 2, in the HEV to which the exemplary embodiments of the present disclosure are applicable, the ICE 110 is controlled by an engine control unit 210, torque of each of the starter generator motor 120 and the drive motor 140 may be controlled by an MCU 220, and the engine clutch 130 may be controlled by a clutch control unit 230. Here, the engine control unit 210 may also be referred to as an engine management system (EMS). Furthermore, a transmission control unit 250 is configured to control the transmission 150.

Each control unit may be connected to an HCU 240, which controls an entire mode conversion process as a parent control unit thereof, to change a driving mode, provide information necessary for controlling the engine clutch during gear shifting and/or information necessary for controlling engine stop to each device, or perform an operation according to a control signal according to control of the HCU 240.

For example, the HCU 240 is configured to determine whether to perform switching between EV-HEV modes or between Charge Depleting (CD)-Charge Sustaining (CS) modes according to a driving state of the vehicle. To the present end, the HCU is configured to determine when the engine clutch 130 is released (open), and is configured to perform hydraulic control when the engine clutch 130 is released. Furthermore, the HCU 240 may be configured to determine a state (lock-up, slip, open, etc.) of the engine clutch 130, and control a fuel injection stop time of the engine 110. Furthermore, the HCU may control recovery of rotational energy of the engine by transmitting a torque command for controlling torque of the starter generator motor 120 to the MCU 220 to control engine stop. Furthermore, the HCU 240 may be configured to determine a mode conversion condition and control a child control unit for conversion when controlling switching of the driving mode. In relation to the exemplary embodiments of the present disclosure, the HCU 240 may be configured to determine whether to control the engine through partial load operation or full load operation.

It is obvious to those skilled in the art that the above-described connection relationship between the control units and a function/classification of each control unit are illustrative, and are not limited to names thereof. For example, the HCU 240 may be implemented so that a corresponding function is replaced and provided in any one of the other control units other than the HCU 240, or a corresponding function may be distributed and provided in two or more of the other control units.

Each of the configurations of FIG. 1 and FIG. 2 described above is only one configuration example of an electrified vehicle, and it will be apparent to those skilled in the art that an electrified vehicle applicable to the exemplary embodiment of the present disclosure is not limited to the present structure.

The HEV according to an exemplary embodiment of the present disclosure includes a control unit of determining a boarding/leaving state of the passengers based on at least one of location information of the vehicle or internal information of the vehicle and whether the vehicle stops after starting the engine, the drive motor, and the vehicle, causing the vehicle to enter a first mode for pick-up driving or a second mode for drop-off driving based on the determined boarding/leaving state and time information, and controlling the vehicle based on the entered mode and a boarding/leaving state after entering. In the present way, an HEV to which a control strategy specific to an HEV repeatedly entered and exited in a fixed manner, such as a school bus, is applied, and a method of controlling the same are provided.

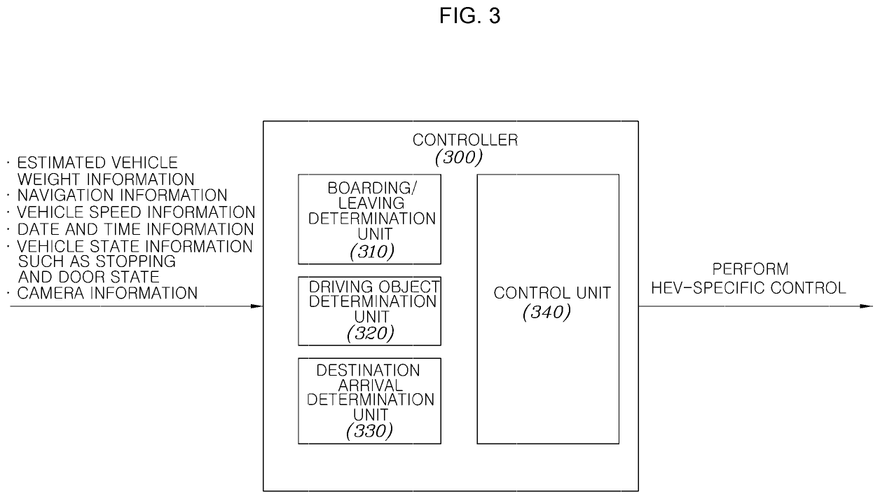

FIG. 3 illustrates an example of a configuration of a controller of the HEV according to an exemplary embodiment of the present disclosure.

Referring to FIG. 3, the controller 300 according to the exemplary embodiment of the present disclosure may have, as input information, estimated vehicle weight information, navigation information, vehicle speed information, date and time information, vehicle state information such as whether the vehicle is stopped and an open state or a closed state of a door in the vehicle, and camera information, and is configured to perform HEV-specific control based on the input information.

Furthermore, the controller 300 may include a boarding/leaving determination unit 310, a driving object determination unit 320, a destination arrival determination unit 330, and a control unit 340.

In implementation, the controller 300 is configured to control the engine 110 and the motors 120 or 140, etc., and thus may have an output value related to the control of the powertrain apparatus. Accordingly, the controller 300 may be implemented as a parent controller that comprehensively is configured to control the powertrain apparatus.

For example, in the case of being applied to the HEV described above with reference to FIG. 1 and FIG. 2, the controller 300 may be implemented as one function of the HCU 240, which is illustrative. The present disclosure is not limited thereto, and the controller 300 may be implemented as a separate controller different from the controllers described above, or as a combination of two or more controllers. The controller 300 may have an output value related to air conditioning control and alarm control, and thus may be implemented as a combination of a plurality of controllers including an air conditioning controller, etc.

Hereinafter, each component of the controller 300 will be described in detail.

First, after the vehicle is started, the boarding/leaving determination unit 310 may be configured to determine a boarding/leaving state of the passengers based on at least one of location information of the vehicle or internal information of the vehicle and whether or not the vehicle is stopped.

Here, after starting the vehicle means that driving is ready so that the vehicle may start when performing an operation necessary for starting the vehicle such as setting a shifting stage to a drive (D) stage and operating an accelerator pedal as in an “HEV Ready” state. In the instant state, when an SOC value of a battery is insufficient or an engine start request occurs due to the demand for air conditioning or catalytic heating, the engine 110 may be started by starting the vehicle. Otherwise, a voltage for driving may be directly applied to the motor 140. However, the definitions and names of these states are illustrative, and are not limited to any definitions or names when driving of the vehicle is ready.

Furthermore, the location information of the vehicle may be obtained through a navigation system provided in the vehicle, and may include, for example, global positioning system (GPS) coordinates. Furthermore, the internal information of the vehicle may include weight information of the vehicle, an open state or a closed state of a door in the vehicle, an accommodated state, a seat belt fastening state, etc.

Meanwhile, the weight information of the vehicle may include a weight detected through a weight sensor provided in the vehicle, or an estimated weight determined based on a result detected through a separate sensor, etc.

For example, the boarding/leaving determination unit 310 may be configured to determine that boarding is started when the vehicle is stopped, location information of the vehicle corresponds to a boarding location such as an apartment complex or a bus stop, and a door is open, and may be configured to determine that boarding is completed when the accommodated state and the weight information satisfy preset conditions.

By considering the location information of the vehicle, etc., in addition to whether or not the vehicle is stopped, it is possible to improve accuracy of determining boarding and leaving, and it is possible to distinguish between a stop due to waiting for a signal by a red light and a stop for boarding and leaving.

Furthermore, the boarding/leaving state determined by the boarding/leaving determination unit 310 may include a state before start of boarding/leaving, a state during boarding/leaving, a state in which the boarding/leaving is completed, etc. in addition to whether the vehicle is simply entered/exited.

Meanwhile, the driving object determination unit 320 may be configured to determine whether pick-up driving or drop-off driving is performed based on the boarding/leaving state and the time information. Pick-up driving may be, for example, driving to school, and drop-off driving may be, for example, driving on the way home from school.

The driving object determination unit 320 may be configured to determine whether pick-up driving or drop-off driving is performed based on a current date and a current time included in the time information. For example, it is possible to determine that driving to school is performed when there is no passenger other than the driver after the vehicle is started in the morning on a weekday, determine that driving on the way home from school is performed when there is a passenger other than the driver after the vehicle is started in the afternoon on a weekday, and determine that both driving to school and driving on the way home from school are not performed when the vehicle is started in the morning or afternoon on a weekend.

Meanwhile, the destination arrival determination unit 330 may be configured to determine whether the vehicle has arrived at a destination. The destination arrival determination unit 330 may be configured to determine whether the vehicle has arrived at the destination based on location information of the vehicle, internal information of the vehicle, whether the vehicle is stopped, etc. For example, when the location information of the vehicle corresponds to the destination input to the navigation system, etc., and the weight inside the vehicle changes or the door is opened while the vehicle is stopped, the destination arrival determination unit 330 may be configured to determine that the vehicle has arrived at the destination.

The boarding/leaving determination unit 310, the driving object determination unit 320, and the destination arrival determination unit 330 provide determination results to the control unit 340, and the control unit 340 may perform specialized control based thereon. Hereinafter, performance of the specialized control of the control unit 340 will be described in detail.

First, the control unit 340 may allow the vehicle to enter a first mode for pick-up driving or a second mode for drop-off driving based on the determination result of the driving object determination unit 320. For example, the first mode may be a going-to-school mode, and the second mode may be a returning-home-from-school mode.

Furthermore, the control unit 340 may control the vehicle according to the entered mode and the boarding/leaving state determined by the boarding/leaving determination unit 310.

When the boarding/leaving state is a state before start of boarding after the vehicle enters the first mode, or the boarding/leaving state is a state before start of leaving after the vehicle enters the second mode, the control unit 340 may perform power control for ensuring an SOC. For example, the control unit 340 may perform power control such as turning off the drive motor 140 and driving the vehicle only through the engine 110, or charging a battery provided in the vehicle through the starter generator motor 120.

In the present way, it is possible to ensure the SOC value of the vehicle in advance, and to further prevent occurrence of restrictions on SOC consumption during performance of subsequent specialized control.

Furthermore, when the boarding/leaving state is a state in which the boarding is started after the vehicle enters the first mode, or when the boarding/leaving state is a state in which the leaving is started after the vehicle enters the second mode, the control unit 340 may control the vehicle so that starting of the engine 110 is stopped.

In the present way, in a boarding/leaving process, it is possible to reduce noise generated by starting the engine 110, alleviate emission of exhaust, and prepare for unexpected accidents.

Meanwhile, when the boarding/leaving state is the state in which boarding is started after the vehicle enters the first mode, or when the boarding/leaving state is the state in which leaving is started after the vehicle enters the second mode, the control unit 340 may control the vehicle so that at least one driving assistance function of the vehicle is activated.

In the present way, a function for assisting in driving of the vehicle after completion of boarding or leaving may be activated in advance, assisting in driving after completion of boarding or leaving.

In the instant case, the driving assistance function may include at least one of a first driving assistance function for suspending a start of the engine 110 and providing driving force through the drive motor 140 while driving in a preset section, a second driving assistance function for limiting at least one of speed or acceleration of the vehicle, or a third driving assistance function for parking assistance.

When driving in a residential area, a school, a children protection area, etc., the first driving assistance function may include a green zone drive mode (GDM) in which the vehicle suspends start of the engine 110 and driving is performed only by the drive motor 140. In the instant case, location information of the vehicle using the navigation system, image information detected by a front camera provided in the vehicle, a driving pattern of the driver, etc. may be used for control.

Furthermore, the third driving assistance function may include a parking assistance function by a parking assistance system (PAS). Furthermore, when the third driving assistance function is activated, the control unit 340 may control the vehicle so that a range to which parking assistance is applied is expanded. For example, if a warning is displayed when the third driving assistance function is activated during normal driving and an external object is detected within 1 m of the vehicle, an application range may be expanded to display a warning when the third driving assistance function is activated during operation in the first mode operation or the second mode and an external object is detected within 2 m of the vehicle.

Meanwhile, when the boarding/leaving state is a state in which the leaving is completed after the vehicle enters the second mode, the control unit 340 may control the vehicle so that a state in which a start of the engine 110 is suspended is maintained until a preset condition is satisfied.

In the instant case, whether the preset condition is satisfied may be determined based on at least one of whether a certain time has elapsed since the boarding/leaving state becomes the state in which leaving is started or whether an object is detected within a certain range from the vehicle.

In the present way, it is possible to prepare for unexpected accidents which may occur due to start of the engine 110 in the boarding/leaving process.

Meanwhile, when the boarding/leaving state is the state in which leaving is completed after the vehicle enters the first mode, the control unit 340 may perform power control for ensuring the SOC until arriving at a preset destination.

Here, whether the vehicle arrives at the destination may be determined by the destination arrival determination unit 330, and power control for ensuring the SOC may be performed such that, for example, the control unit 340 turns off the drive motor 140 and the vehicle is driven only by the engine 110, or the battery provided in the vehicle is charged through the starter generator motor 120.

In the present way, it is possible to ensure the SOC value of the vehicle in advance, and to further prevent occurrence of restrictions on SOC consumption during performance of subsequent specialized control.

Meanwhile, when the vehicle arrives at the preset destination after entering the first mode, the control unit 340 may control the vehicle so that a start of the engine 110 is suspended. Furthermore, the control unit 340 may control the vehicle so that a state in which a start of the engine 110 is suspended is maintained until a preset condition is satisfied after arriving at the destination.

In the instant case, whether the preset condition is satisfied may be determined based on at least one of whether a certain time has elapsed since the vehicle arrives at the preset destination or whether an object is detected within a certain range from the vehicle.

Meanwhile, when a passenger is detected in the vehicle after the boarding/leaving state becomes the state in which leaving is started after the vehicle enters the second mode, the control unit 340 may perform at least one of air conditioning control or alarm control. In the present way, it is possible to mitigate a risk of an accident occurring when a passenger not leaving is trapped inside the vehicle.

Meanwhile, the control unit 340 may perform a control operation so that the vehicle releases the first mode or the second mode based on at least one of the location information of the vehicle or the internal information of the vehicle, and whether the vehicle is stopped.

For example, the control unit 340 may allow the vehicle to release the first mode when the location information of the vehicle corresponds to a location outside the apartment complex, the bus stop, etc., and weight information of the internal information of the vehicle is greater than or equal to a preset weight, or a vehicle speed is greater than or equal to a preset speed, and may allow the vehicle to release the second mode when the location information of the vehicle is outside the apartment complex, the bus stop, etc., and the weight information of the internal information of the vehicle is less than or equal to the preset weight, or the vehicle speed is greater than or equal to the preset speed.

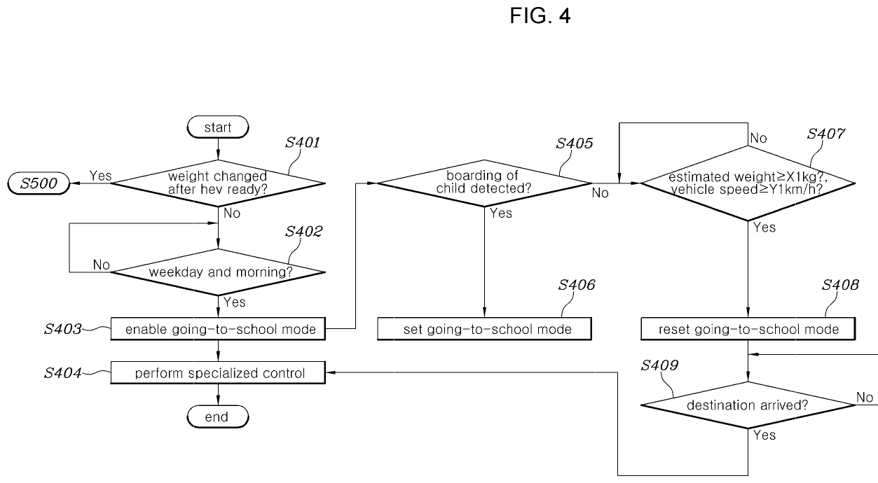

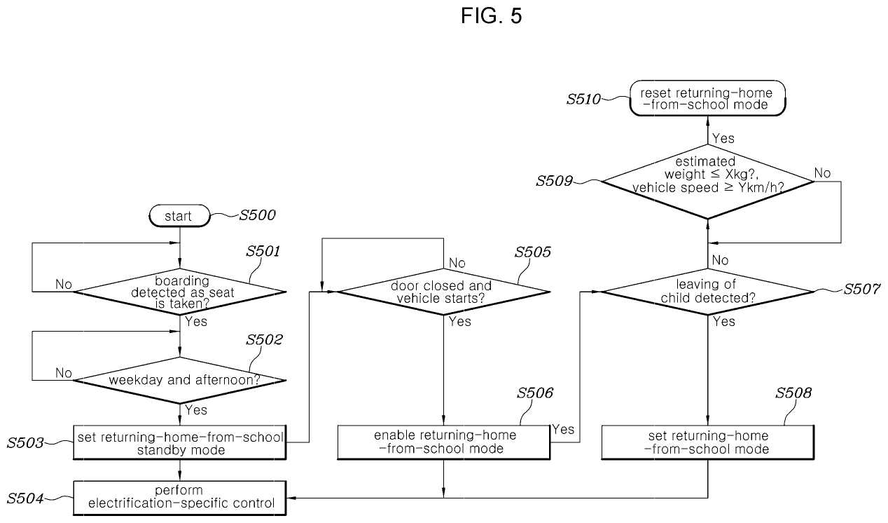

Hereinafter, a control process of the HEV according to an exemplary embodiment of the present disclosure will be described with reference to FIG. 4 and FIG. 5.

In the following description with reference to FIG. 4 and FIG. 5, it is assumed that the HEV according to the exemplary embodiment of the present disclosure is applied to a kindergarten bus.

First, FIG. 4 is a diagram for describing the first mode operation of the HEV according to an exemplary embodiment of the present disclosure.

Referring to FIG. 4, when there is no change in weight after the vehicle is started (HEV Ready), that is, no other passenger is on the vehicle after the driver has boarded (no in S401), and the time information corresponds to weekday and morning (yes in S402), the control unit 340 may allow the vehicle to enter a going-to-school mode enabled state in the first mode (S403). After entering the going-to-school mode enabled state, the control unit 340 is configured to perform specialized control corresponding to the going-to-school mode enabled state (S404), and the specialized control corresponding to the going-to-school mode enabled state may be, for example, the above-described power control for ensuring the SOC.

When boarding of a child is detected in the going-to-school mode enabled state (yes in S405), the control unit 340 may allow the vehicle to enter a going-to-school mode set state in the first mode (S406), and perform specialized control corresponding to the going-to-school mode set state (S404). In the instant case, the specialized control corresponding to the going-to-school mode set state may include start suspension control of the engine 110 described above and driving assistance function activation control.

On the other hand, when boarding of a child is not detected in the going-to-school mode enabled state (no in S405), the going-to-school mode may be released based on the location information of the vehicle, the internal information of the vehicle, whether the vehicle is stopped, etc. For example, when an estimated weight in the internal information of the vehicle is greater than or equal to a preset weight, and the vehicle speed is greater than or equal to a preset speed (yes in S407), the control unit 340 may release the going-to-school mode (that is, reset the going-to-school mode) (S408).

Specialized control may be performed in a going-to-school mode reset state. For example, the control unit 340 may perform power control for ensuring the SOC until arrival at the destination in the going-to-school mode reset state (S404). Thereafter, when the vehicle arrives at the destination (yes in S409), corresponding specialized control is performed. For example, the control unit 340 may suspend start of the engine 110 upon arrival at the destination, and control the vehicle so that a state in which the engine 110 is suspended is maintained until a preset condition is satisfied (S404).

FIG. 4 relates to a process of operating the vehicle in the first mode according to an exemplary embodiment of the present disclosure, and a process of operating the vehicle in the second mode will be described below with reference to FIG. 5.

FIG. 5 is a diagram for describing the second mode operation of the HEV according to an exemplary embodiment of the present disclosure.

In FIG. 4, when a weight change is detected after starting the vehicle (yes in S401), a process of FIG. 5 may be started (S500). When boarding is detected as a seat is taken (yes in S501), and it is the afternoon on a weekday (yes in S502), the vehicle may be allowed to enter a returning-home-from-school standby mode set state in the second mode. The control unit 340 may perform specialized control so that a start of the engine 110 is suspended in the returning-home-from-school standby mode set state (S504).

Meanwhile, when the door is closed after entering the returning-home-from-school standby mode set state, the vehicle starts, and a stop state ends (yes in S505), the control unit 340 may perform a control operation so that the vehicle enters a returning-home-from-school mode enabled state (S506), and perform power control for ensuring the SOC.

Thereafter, when leaving of a child is detected (yes in S507), the control unit 340 may allow the vehicle to enter a returning-home-from-school mode set state (S508), and perform specialized control such as suspension of start of the engine 110, maintaining suspension of start of the engine 110, and activation of the driving assistance function.

When leaving is not detected (no in S507), it is determined whether to initialize the returning-home-from-school mode. For example, when the estimated weight in the internal information of the vehicle is less than or equal to a preset value, and the vehicle speed is greater than or equal to a preset speed, the returning-home-from-school mode may be released.

According to various embodiments of the present disclosure as described above, it is possible to efficiently utilize the HEV according to a driving situation, and it is possible to mitigate occurrence of accidents while driving and boarding/leaving of passengers. Furthermore, it is possible to reconsider marketability by making the HEV specialized for use such as a school bus.

The effects obtainable in an exemplary embodiment of the present disclosure are not limited to the effects mentioned above, and other effects not mentioned herein may be clearly understood by those skilled in the art from the above description.

Furthermore, the term related to a control device such as “controller”, “control apparatus”, “control unit”, “control device”, “control module”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may process data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the scope of the present disclosure includes software or machine-executable commands (e.g., an operating system, an application, firmware, a program, etc.) for facilitating operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A hybrid electric vehicle (HEV) comprising:
an engine;
a drive motor; and
a controller configured to determine a boarding state or a leaving state of a passenger based on at least one of location information of the vehicle or internal information of the vehicle and whether the vehicle is stopped after the vehicle is started, to allow the vehicle to enter a mode among a first mode for pick-up driving or a second mode for drop-off driving based on the determined boarding state or the determined leaving state and time information, and to control the vehicle based on the entered mode and the boarding state or the leaving state after the entering.

2. The HEV of claim 1, wherein the internal information of the vehicle includes weight information of the vehicle, an open state or a closed state of a door in the vehicle, an accommodated state, or a seat belt fastening state.

3. The HEV of claim 1, wherein the boarding state or the leaving state includes at least one of a state before boarding or leaving starts, a state in which the boarding or the leaving is started, or a state in which the boarding or the leaving is completed.

4. The HEV of claim 3, wherein, when the boarding state or the leaving state is a state before the boarding starts after the vehicle enters the first mode, or the boarding state or the leaving state is a state before the leaving starts after the vehicle enters the second mode, the controller is configured to perform power control for ensuring a state of charge (SOC).

5. The HEV of claim 3, wherein, when the boarding state or the leaving state is a state in which the boarding is started after the vehicle enters the first mode, or the boarding state or the leaving state is a state in which the leaving is started after the vehicle enters the second mode, the controller is configured to control the vehicle so that a start of the engine is suspended.

6. The HEV of claim 3, wherein, when the boarding state or the leaving state is a state in which the boarding is started after the vehicle enters the first mode, or the boarding state or the leaving state is a state in which the leaving is started after the vehicle enters the second mode, the controller is configured to control the vehicle so that at least one driving assistance function of the vehicle is activated.

7. The HEV of claim 6, wherein the at least one driving assistance function is at least one of a first driving assistance function for suspending a start of the engine and providing driving force through the drive motor while driving in a preset section, a second driving assistance function for limiting at least one of speed or acceleration of the vehicle, or a third driving assistance function for parking assistance.

8. The HEV of claim 7, wherein, when the third driving assistance function is activated, the controller is configured to control the vehicle so that a range to which the parking assistance is applicable is expanded.

9. The HEV of claim 3, wherein, when the boarding state or the leaving state is a state in which the leaving is completed after the vehicle enters the second mode, the controller is configured to control the vehicle so that a state in which a start of the engine is suspended is maintained until a preset condition is satisfied.

10. The HEV of claim 9, wherein whether the preset condition is satisfied is determined based on at least one of whether a predetermined time period has elapsed because the boarding state or the leaving state becomes a state in which the leaving is started or whether an object is detected within a predetermined range from the vehicle.

11. The HEV of claim 3, wherein, when the boarding state or the leaving state is a state in which the leaving is completed after the vehicle enters the first mode, the controller is configured to perform power control for ensuring an SOC until arriving at a preset destination.

12. The HEV of claim 3, wherein, when the vehicle arrives at a preset destination in a state in which the vehicle enters the first mode, the controller is configured to control the vehicle so that a start of the engine is suspended.

13. The HEV of claim 3, wherein, when the vehicle arrives at a preset destination in a state in which the vehicle enters the first mode, the controller is configured to perform a control operation so that a state in which a start of the engine is suspended is maintained until a preset condition is satisfied.

14. The HEV of claim 13, wherein whether the preset condition is satisfied is determined based on at least one of whether a predetermined time period has elapsed because the vehicle arrives at the preset destination, or whether an object within a predetermined range from the vehicle is detected.

15. The HEV of claim 3, wherein, when the passenger is detected in the vehicle after the boarding state or the leaving state becomes a state in which the leaving is started after the vehicle enters the second mode, the controller is configured to perform at least one of air conditioning control or alarm control.

16. The HEV of claim 3, wherein, when the passenger boards the vehicle in a state in which the vehicle enters the second mode, the controller is configured to perform a control operation so that a start of the engine is suspended.

17. The HEV of claim 1, wherein the controller is configured to perform a control operation so that the vehicle releases the first mode or the second mode based on at least one of the location information of the vehicle or the internal information of the vehicle and whether the vehicle is stopped.

18. A method of controlling a hybrid electric vehicle (HEV), the method comprising:
determining, by a controller, a boarding state or a leaving state of a passenger based on at least one of location information of the vehicle or internal information of the vehicle and whether the vehicle is stopped after the vehicle is started; and
allowing, by the controller, the vehicle to enter a mode among a first mode for pick-up driving or a second mode for drop-off driving based on the determined boarding state or the determined leaving state and time information, and controlling the vehicle based on the entered mode and the boarding state or the leaving state after the entering.

19. The method of claim 18, wherein the controller is configured to perform a control operation so that the vehicle releases the first mode or the second mode based on at least one of the location information of the vehicle or the internal information of the vehicle and whether the vehicle is stopped.

20. A non-transitory computer readable storage medium on which a program for performing the method of claim 18 is recorded.
